(19) United States
(12) Patent Application Publication
(10) Pub. No.: US 2026/0235773 A1
(43) Pub. Date: Aug. 13, 2026

(54) GPS AUGMENTATION USING QUANTUM SENSING FOR VEHICLE PARKING

(71) Applicant: Toyota Motor Engineering & Manufacturing North America, Inc., Plano, TX (US)

(72) Inventors: Ercan M. DEDE, Ann Arbor, MI (US); Debasish BANERJEE, Ann Arbor, MI (US); Paul D. SCHMALENBERG, Ann Arbor, MI (US)

(73) Assignees: Toyota Motor Engineering & Manufacturing North America, Inc., Plano, TX (US); Toyota Jidosha Kabushiki Kaisha, Toyota-Shi (JP)

(21) Appl. No.: 19/049,841

(22) Filed: Feb. 10, 2025

(51) Int. Cl. G01S 19/47; B60W 60/00; G08G 1/14

(52) U.S. Cl. CPC G01S 19/47; B60W 60/001; G08G 1/143

(57) ABSTRACT

A system for use with a vehicle is disclosed. The system includes: a quantum material magnetometer configured to measure a magnetic field in an area and to output an area signal based on the magnetic field in the area; and an augmented positioning system configured output a parking instruction signal based on the area signal.

### TECHNICAL FIELD

One or more embodiments relate generally to systems and methods of autonomously or semi-autonomously parking a vehicle.

### BACKGROUND

As is well known, global positioning systems (GPS) use satellites and sensors to provide a location information. A vehicle uses a GPS sensor to find its location on the Earth. However, GPS sensors are not precise enough to some applications. For example, a GPS sensor may be desirable to more precisely determine a location, such as when a user is trying to find a location of an individual parking spot.

What is needed is a system and method for a vehicle to autonomously find an available individual parking spot with centimeter length scale precision.

### SUMMARY

An aspect of the present disclosure is drawn to a system for use with a vehicle. The system includes: a quantum material (QM) magnetometer configured to measure a magnetic field in an area and to output an area signal based on the magnetic field in the area; and an augmented positioning system configured to output a parking instruction signal based on the area signal.

In one or more embodiments of this aspect, the system further includes a memory having a magnetic field map database stored therein, the magnetic field map database including data associated with a previously recorded magnetic field of the area. In one or more of these embodiments, the magnetic field map database includes local magnetic field databases including data associated with magnetic fields at different areas, wherein the data associated with magnetic fields at each respective area of the different areas is created from an accumulation a plurality of data as output from different QM magnetometers, each of which is configured to measure magnetic fields. In one or more of these embodiments, the data associated with magnetic fields at each respective area of the different areas is created from an accumulation a plurality of data as output from different QM magnetometers over time, each of which is configured to measure magnetic fields. In one or more of these embodiments, the memory additionally has a seasonal magnetic field map database stored therein, the seasonal magnetic field map database including data associated with a previously recorded magnetic field of the area based on a plurality of different time periods. In one or more of these embodiments, the seasonal magnetic field map database including data associated with a previously recorded magnetic field of the area based on a plurality of different time periods of a given year and/or season.

In one or more embodiments of this aspect, the system further includes an indicator configured to indicate a location of an available parking space associated with the area for the vehicle, wherein the augmented positioning system includes: a memory having parking-assist executable instructions stored therein; and a processor configured to execute the parking-assist executable instructions to cause the indicator to indicate the location of the available parking space based on the parking instruction signal. In one or more of these embodiments, the indicator includes at least one of a display and a speaker, wherein when the indicator includes a display, the indicator is configured to indicate the location of the available parking space for the vehicle as a visual indicator including at least one of an icon or an image of the available parking space, and wherein when the indicator includes a speaker, the indicator is configured to indicate the location of the available parking space for the vehicle as an audio signal configured to cause the speaker to output a predetermined sound. In one or more of these embodiments, the predetermined sound includes a series of driver instructions.

In one or more embodiments of this aspect, the system further includes a drive assist system configured to modify a position, a velocity, an acceleration, or combination thereof, of the vehicle based on the parking instruction signal, wherein the vehicle is an automated vehicle.

Another aspect of the present disclosure is drawn to a method including: measuring, via a QM magnetometer, a magnetic field in an area; outputting, via the QM magnetometer, an area signal based on the magnetic field in the second area; and outputting, via an augmented positioning system, a parking instruction signal based on the area signal.

In one or more embodiments of this aspect, the outputting of the second area signal includes analyzing, via the augmented positioning system, magnetic field map database stored within a memory, the magnetic field map database including data associated with a previously recorded magnetic field of the area. In one or more of these embodiments, the magnetic field map database includes local magnetic field databases including data associated with magnetic fields at different areas, wherein the data associated with magnetic fields at each respective area of the different areas is created from an accumulation a plurality of data as output from different QM magnetometers., each of which is configured to measure magnetic fields. In one or more of these embodiments, the data associated with magnetic fields at each respective area of the different areas is created from an accumulation a plurality of data as output from different QM magnetometers over time, each of which is configured to measure magnetic fields. In one or more of these embodiments, the outputting the second area signal further includes analyzing, via the augmented positioning system, a seasonal magnetic field map database stored within the memory, the seasonal magnetic field map database including data associated with a previously recorded magnetic field of the area based on a plurality of different time periods. In one or more of these embodiments, the seasonal magnetic field map database including data associated with a previously recorded magnetic field of the area may be based on a plurality of different time periods of a given year and/or season.

In one or more embodiments of this aspect, the method further includes: indicating, via an indicator, a location of an available parking space associated with the area for a vehicle, wherein the outputting of the parking instruction signal includes executing, via a processor, parking-assist executable instructions stored within a memory to cause the indicator to indicate the location of the available parking space based on the parking instruction signal. In one or more of these embodiments, the indicating the location includes indicating via at least one of a display and a speaker, wherein when the indicating of the location includes indicating via the display, the indicating of the location includes indicating the location of the available parking space for the vehicle as a visual indicator including at least one of an icon or an image of the available parking space, and wherein when the indicating of the location includes indicating via the speaker, the indicating of the location includes indicating the location of the available parking space for the vehicle as an audio signal configured to cause the speaker to output a predetermined sound. In one or more of these embodiments, the predetermined sound includes a series of driver instructions.

In one or more embodiments of this aspect, the method further includes modifying, via a drive assist system, a position, a velocity, an acceleration, or combination thereof, of the vehicle based on the parking instruction signal, wherein the vehicle is an automated vehicle.

Another aspect of the present disclosure is drawn to non-transitory, computer-readable media having computer-readable instructions stored thereon, the computer-readable instructions being capable of being read by a system, wherein the computer-readable instructions are capable of instructing the system to perform a method including: measuring, via a QM magnetometer, a magnetic field in an area; outputting, via the QM magnetometer, an area signal based on the magnetic field in the area; and outputting, via an augmented positioning system, a parking instruction signal based on the area signal.

In one or more embodiments of this aspect, the outputting of the second area signal includes analyzing, via the augmented positioning system, magnetic field map database stored within a memory, the magnetic field map database including data associated with a previously recorded magnetic field of the area. In one or more of these embodiments, the magnetic field map database includes local magnetic field databases including data associated with magnetic fields at different areas, wherein the data associated with magnetic fields at each respective area of the different areas is created from an accumulation a plurality of data as output from different QM magnetometers, each of which is configured to measure magnetic fields. In one or more of these embodiments, the data associated with magnetic fields at each respective area of the different areas is created from an accumulation a plurality of data as output from different QM magnetometers over time, each of which is configured to measure magnetic fields. In one or more of these embodiments, the outputting the second area signal further includes analyzing, via the augmented positioning system, a seasonal magnetic field map database stored within the memory, the seasonal magnetic field map database including data associated with a previously recorded magnetic field of the area based on a plurality of different time periods. In one or more of these embodiments, the seasonal magnetic field map database including data associated with a previously recorded magnetic field of the area based on a plurality of different time periods of a given year and/or season.

In one or more embodiments of this aspect, the computer-readable instructions are capable of instructing the system to perform the method further including: indicating, via an indicator, a location of an available parking space associated with the area for a vehicle, wherein the outputting the parking instruction signal includes executing, via a processor, parking-assist executable instructions stored within a memory to cause the indicator to indicate the location of the available parking space based on the parking instruction signal. In one or more of these embodiments, the indicating the location includes indicating via at least one of a display and a speaker, wherein when the indicating the location includes indicating via the display, the indicating the location includes indicating the location of the available parking space for the vehicle as a visual indicator including at least one of an icon or an image of the available parking space, and wherein when the indicating the location includes indicating via the speaker, the indicating the location includes indicating the location of the available parking space for the vehicle as an audio signal configured to cause the speaker to output a predetermined sound. In one or more of these embodiments, the predetermined sound includes a series of driver instructions.

### DRAWINGS

The accompanying drawings, which are incorporated in and form a part of the specification, illustrate and explain example embodiments. In the drawings:

FIG. 1 illustrates a schematic top-down view of a portion of a city;

FIG. 2 illustrates a top down view of the parking lot of the portion of the city of FIG. 1 with an overlay of a global positioning system grid;

FIG. 3 illustrates a top down view of the parking lot of the portion of the city of FIG. 1 with an overlay of a QM magnetometer detection grid in accordance with aspects of the present disclosure;

FIG. 4 illustrates a portion of the parking lot of the portion of the city of FIG. 1;

FIG. 5 illustrates the portion of the parking lot of FIG. 3, as detected by a QM system in accordance with aspects of the present disclosure;

FIG. 6A illustrates a vehicle scanning a portion of the parking lot of the portion of the city of FIG. 1 at a time t₀;

FIG. 6B illustrates the vehicle of FIG. 6A scanning a portion of the parking lot of the portion of the city of FIG. 1 at a time t₁;

FIG. 7 illustrates a method of generating a parking instruction signal using a QM system in accordance with aspects of the present disclosure;

FIG. 8 illustrates a block diagram of the vehicle of FIG. 1 in accordance with aspects of the present disclosure;

FIG. 9 illustrates a block diagram of the sensor system of the vehicle of FIG. 8;

FIG. 10 illustrates a block diagram of the data bases of the memory of the vehicle of FIG. 8; and

FIG. 11 illustrates a block diagram of the infotainment system of the vehicle of FIG. 8.

### DESCRIPTION

In accordance with aspects of the present disclosure, a quantum material (QM) sensor system may accurately and precisely determine a precise location without the need for a GPS sensor.

In one or more embodiments, a QM sensor system is configured to find a precise location of a target destination. The QM sensor system can provide more precision location information than a GPS sensor alone.

In one or more embodiments, GPS navigation may be augmented, or even replaced, using a QM sensor system for precise location of a target destination through local mapping of the Earth's magnetic field.

QM sensors are devices that can detect very minute variations in magnetic or electrical fields. Locations will have unique magnetic “fingerprints” due to the magnetic field of the Earth. In one or more embodiments of the present disclosure, local reference magnetic field maps are generated in parking lots over time using QM sensors embedded in both traditional and autonomous vehicles. For example, vehicles equipped with QM sensors can generate data regarding local magnetic fields over time through regular usage. An analogy is how lidar maps are generated by vehicles equipped with lidar scanners that scan the environment to build maps over days-to-years.

A non-limiting example QM sensor system that may be used in accordance with one or more embodiments of the present disclosure is a QM magnetometer.

A QM magnetometer is a highly sensitive device that uses quantum mechanics principles to measure magnetic fields with precision and spatial resolution. Quantum magnetometers exploit the quantum properties of certain materials or systems to detect magnetic fields. They typically rely on at least one of spin states of subatomic particles (e.g., electrons, nuclei), quantum superposition and entanglement, and energy level transitions in atoms or defects in solid-state materials such as diamond or hexagonal boron nitride (hBN). These devices can detect extremely weak magnetic fields, often with sensitivities reaching the femtotesla (10⁻¹⁵ T) range. Some quantum magnetometers can achieve spatial resolutions down to a few nanometers, allowing for the detection of magnetic fields from individual electron or nuclear spins. Non-limiting types of QM magnetometers include: solid-state diamond-based magnetometers, which use nitrogen-vacancy (NV) centers in diamond to detect magnetic fields, offer high spatial resolution and can be realized using photonics chip-based technologies that operate at room temperature; optically pumped magnetometers (OPMs), which use alkali metal vapors (e.g., cesium, rubidium) and optical pumping techniques to achieve high sensitivity; superconducting quantum interference devices (SQUIDs), which while requiring cryogenic cooling, offer extremely high sensitivity for certain applications; and Overhauser magnetometers, which use dynamic nuclear polarization to enhance proton precession signals, offering high sensitivity and continuous operation capabilities.

Local magnetic field maps can then be used to supplement, or even supplant, GPS data to provide more precise geo-locational information. A QM sensor system and a GPS module in a vehicle work together with maps to determine a cm-scale precise location. The QM sensor system detects the minute changes in the magnetic field and compares the changes with a local magnetic field map to determine the precise geolocation.

This information can be used to find a precise target location, such as a parking space within a parking garage or surface lot, for example. An autonomous vehicle may then park itself with extreme precision using such a system or a vehicle infotainment system may alert the driver of a non-autonomous vehicle exactly where a parking space is available.

Note that seasonal patterns in magnetic field variation may be accounted for in supplementing the historical database. Additionally, a person in a vehicle with a QM magnetometer can detect which parking space in a two-dimensional surface lot or three-dimensional parking structure might be already occupied due to local disturbances in the associated spatial magnetic field.

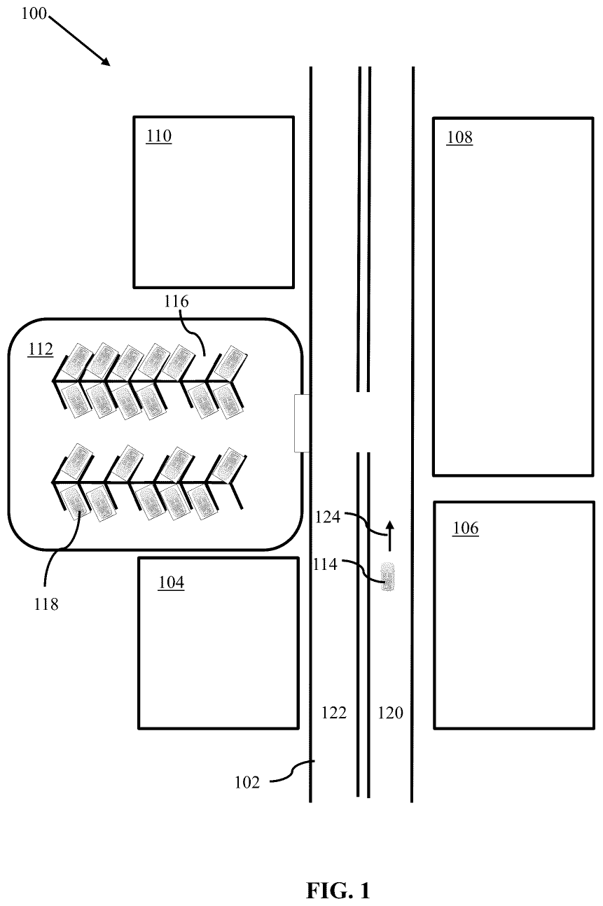

A more detailed explanation of a system and method for augmenting autonomous driving using quantum sensing for vehicle parking in accordance with aspects of the present disclosure will now be described in greater detail with reference to FIGS. 1-11.

FIG. 1 illustrates a schematic top-down view of a portion of a city 100. As shown in the figure, city 100 includes a road 102, a building 104, a building 106, a building 108, a building 110, and a parking lot 112. A vehicle 114 is driving on road 102. Parking lot 112 includes a plurality of parking spaces, a sample of which is indicated a parking space 116. A plurality of vehicles are parked in some of the parking spaces, a sample of which is indicated as parked vehicle 118. Road 102 includes a northbound lane 120 and a southbound lane 122, wherein vehicle 114 is driving on northbound lane 120 at a velocity indicated by arrow 124.

For purposes of discussion, consider the situation where the driver of vehicle 114 is driving toward parking lot 112, so as to park vehicle 114 into an empty parking space within parking lot 112.

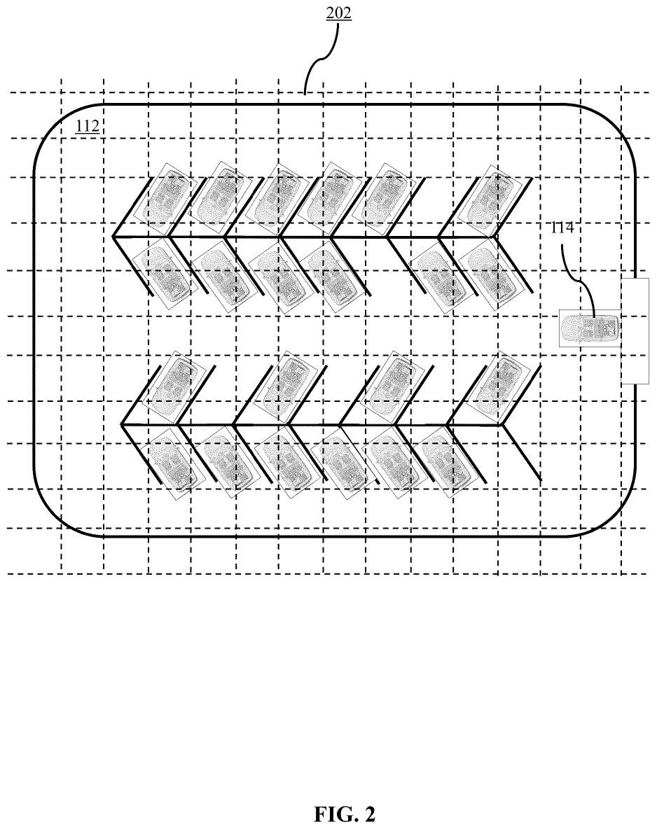

FIG. 2 illustrates a top down view of parking lot 112 with an overlay 202 of a GPS grid. As shown in the figure, vehicle 114 has entered parking lot 112 in search of an empty parking space for which to park. As shown in the figure, the GPS navigation system of vehicle 114 has an accuracy on the order of about 3-4 meters. As a result, the 3-4 meter accuracy is insufficient for an autonomous or semi-autonomous parking system to safely park within an empty parking spot using a GPS signal alone.

Autonomous parking, also known as fully autonomous parking or autonomous valet parking (AVP), offers a completely hands-off experience. An AVP system can park a vehicle without any human intervention. A semi-autonomous parking system, often called active park assist or intelligent parking assist system (IPAS), requires some level of driver involvement. For example, an IPAS may handle steering, whereas the driver may need to control acceleration and braking. In an IPAS, the driver typically remains in the vehicle during the parking process.

Using a QM magnetometer that is able to precisely detect magnetic fields, an autonomous or semi-autonomous vehicle may be able to augment its navigation capabilities to park into an empty parking space within parking lot 112.

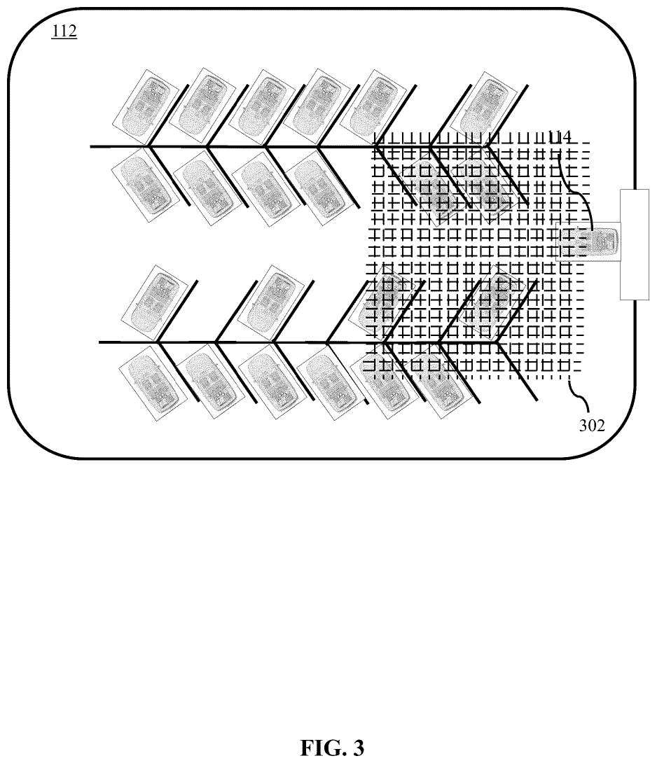

FIG. 3 illustrates a top down view of parking lot 112 with an overlay of a QM magnetometer detection grid 302 in accordance with aspects of the present disclosure. As shown in the figure, the QM system of vehicle 114 has an accuracy on the order of centimeters. As a result, the centimeter-scale accuracy is sufficient for an autonomous or semi-autonomous parking system to safely park within an empty parking spot.

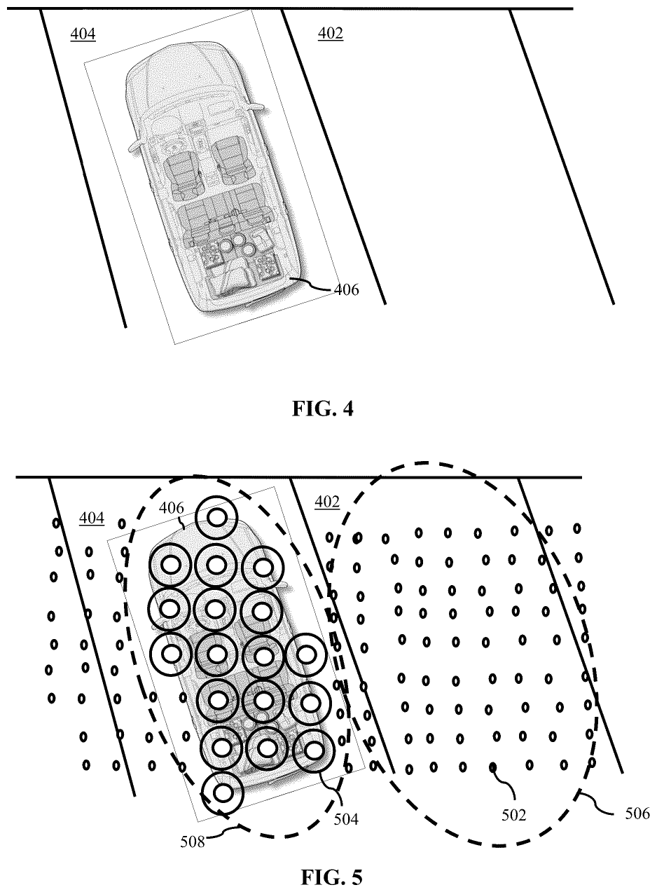

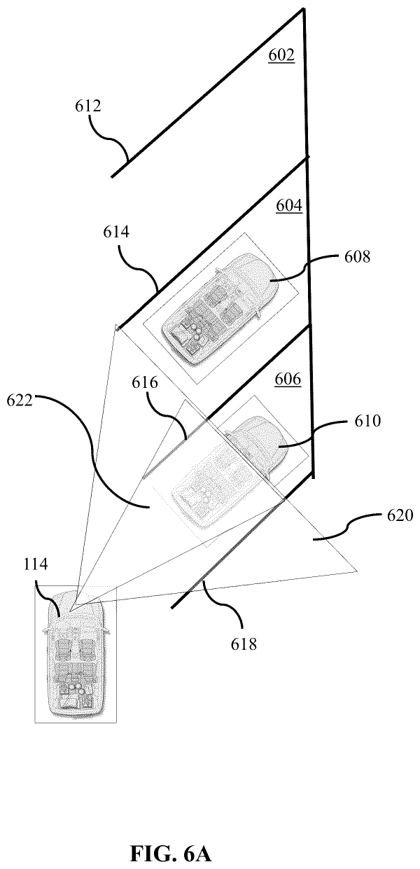

The operation of a QM system to detect an available parking space in accordance with aspects of the present disclosure will now be described in greater detail with reference to FIGS. 4-5.

FIG. 4 illustrates a portion of parking lot 112. As shown in the figure, parking lot 112 includes an empty parking space 402 and a parking space 404 having a vehicle 406 parked therein.

It should be noted that the Earth has a magnetic field. More accurately, the magnetic field within any area on Earth may be mapped as a vector field having a magnitude and direction. The magnitude and direction may vary slightly based on a number of factors, the largest of which is based on an amount of iron. This will be described in greater detail with reference to FIG. 5.

FIG. 5 illustrates the portion of parking lot 112 of FIG. 4, as detected by a QM system in accordance with aspects of the present disclosure. As shown in FIG. 5, empty parking space 402 and parking space 404 include detected magnetic fields 502 and detected magnetic fields 504. In this example, detected magnetic fields 504 are four orders of magnitude larger than detected magnetic fields 502. The increase in magnitude of detected magnetic fields 504 over that of detected magnetic fields 502 is a result of metal, particularly iron within stainless steel components of vehicle 406.

In particular, iron is a ferromagnetic material, wherein electrons within the iron generate tiny magnetic fields. These electrons tend to align with each other and with external magnetic fields. In this situation, the external magnetic fields are those produced by the Earth under parking lot 112. For iron, the magnetic field can be amplified by a factor of approximately 10,000.

In this example, the space for which vehicle 406 is disposed is easily distinguishable from the other areas without a vehicle. In particular, an area 508 within parking space 404 for which vehicle 406 is located has detected magnetic fields 504. However, the other areas have detected magnetic fields 502, which have a much lower magnitude than detected magnetic fields 504. In particular an area 506 within parking space 402 has detected magnetic fields 502. Note that the extent of the area 508 in terms of magnetic field influence is not necessarily limited to the immediate area of the parking space 404, as shown, and it practice the magnetic fields 504 create larger magnetic field disturbances or gradients in the surrounding area which may be interpreted as a broader magnetic field contour map that is overlaid on a larger parking lot 112. Therefore, in accordance with aspects of the present disclosure, the presence of a vehicle may be easily and precisely identified via a QM magnetometer that passes through or adjacent to the parking lot 112 when compared with a historical magnetic field contour map database.

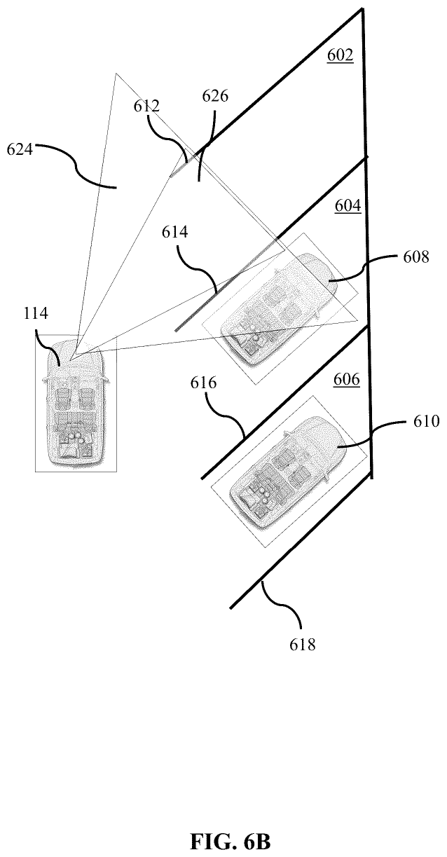

A system and method using quantum sensing for vehicle parking in accordance with aspects of the present disclosure exploits the effects of iron on magnetic fields for augmenting autonomous parking. This will be described in greater detail with reference to FIGS. 6A-B.

FIG. 6A illustrates vehicle 114 scanning a portion of parking lot 112 at a time t₀.

As shown in the figure, parking lot 112 includes parking spaces 602, 604, and 606, and parked vehicles 608 and 610. Parked vehicle 608 is parked within parking space 604, whereas parked vehicle 610 is parked within parking space 606. Parking space 602 is empty. Parking space 602 is bounded on one side by a line 612 and bounded on the other side by a line 614. Parking space 604 is bounded on one side by line 614 and bounded on the other side by a line 616. Parking space 606 is bounded on one side by line 616 and bounded on the other side by a line 618.

Vehicle 114, includes a camera configured to image an area 620 and a QM system configured to detect magnetic fields within an area 622.

In some autonomous or semi-autonomous parking systems, images from a vehicle camera may be used to assist with parking, wherein predetermined objects are identified by the control system of the vehicle, such as parking lines, walls, curbs, other vehicles, etc. However, in accordance with aspects of the present disclosure, information from a camera may be replaced with or supplemented with information related to detected magnetic fields.

In this example, let image data from area 620 as captured by the camera be used by vehicle 114 to identify parking space 606 and vehicle 610. In this situation, vehicle 114 may determine that parking space 606 is not available as a result of the presence of vehicle 610. Further, as an alternative to using image data from area 620 as captured by the camera, or in one or more embodiments, to supplement using image data from area 620, the magnetic fields within area 622 and the immediate surrounding area of parking lot 112 are detected by a QM system.

In particular, in a manner similar to that as discussed above with reference to FIGS. 4-5, the QM system of vehicle 114 may detect magnetic fields of a high order of magnitude, which would indicate the presence of a vehicle within parking space 606. As such, vehicle 114 would not attempt to park into parking space 606.

For example, in some situations, lighting may inhibit a camera from identifying any of lines 616 and 618 or vehicle 610. In this manner, image data from the camera may not enable vehicle 114 to sufficiently identify parking space 606 or that parking space 606 is occupied by vehicle 610. However, as discussed above with reference to FIG. 5, a QM system may (through comparison of a magnetic field contour map and comparison with historical databases) easily identify a space that includes a vehicle as a result of the detected increased magnetic field, thus enabling vehicle 114 to sufficiently identify parking space 606 as being occupied by vehicle 610.

In this manner, vehicle 114 may continue to drive along the parking spaces in the lot until an unoccupied space is detected, at which time the highly localized QM system may further facilitate the autonomous driving system for highly precise (cm-scale) navigation into the empty parking space.

FIG. 6B illustrates vehicle 114 of FIG. 6A scanning at a time t₁.

Again, in this example, let image data from area 624 as captured by the camera be used by vehicle 114 to identify parking space 602. In this situation, vehicle 114 may determine that parking space 602 is available. Further, as an alternative to using image data from area 624 as captured by the camera, or in one or more embodiments, to supplement using image data from area 624, the magnetic fields within and surrounding an area 626 are detected by a QM system.

In particular, in a manner similar to that as discussed above with reference to FIGS. 4-5, a QM system of vehicle 114 may detect magnetic fields of a much lower order of magnitude, which would indicate no presence of a vehicle within parking space 602. As such, vehicle 114 may attempt to park into parking space 602 with assistance of cm-scale navigation enabled by the QM system.

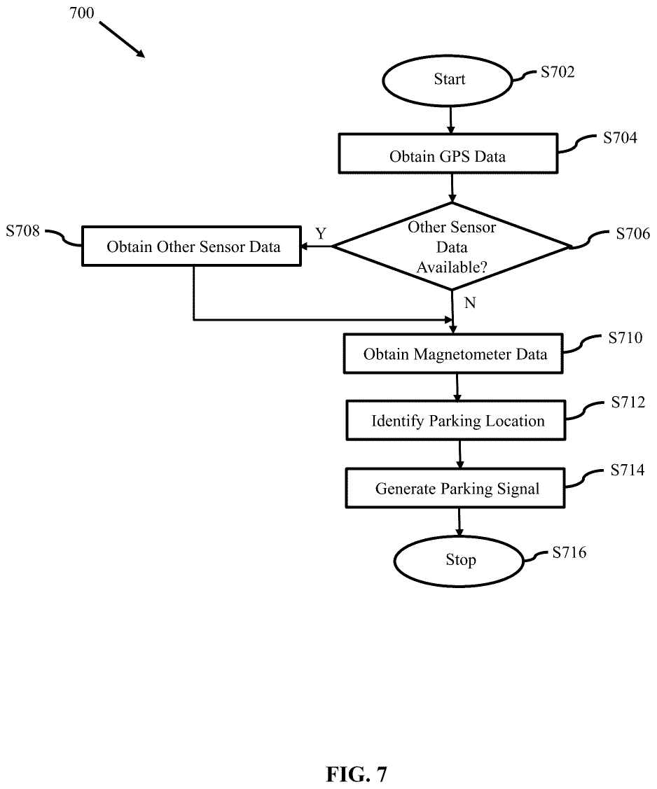

FIG. 7 illustrates a method 700 of generating a parking instruction signal using a QM system in accordance with aspects of the present disclosure.

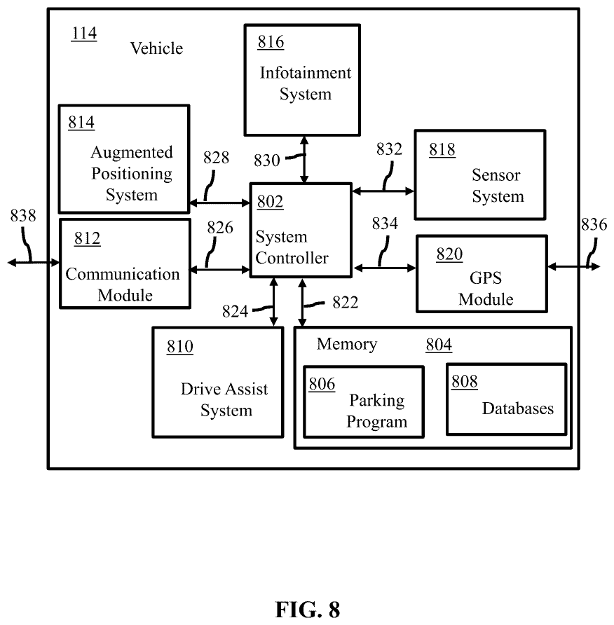

As shown in the figure, method 700 starts (S702) and coarse vehicle positioning GPS data is obtained (S704). This will be described in greater detail with reference to FIG. 8.

FIG. 8 illustrates a block diagram of vehicle 114 in accordance with aspects of the present disclosure.

As shown in the figure, vehicle 114 includes a system controller 802, a memory 804 having a parking program 806 and databases 808 stored therein, a drive assist system (DAS) 810, a communication module 812, an augmented positioning system (APS) 814, an infotainment system 816, a sensor system 818, a GPS module 820, and communication channels 822, 824, 826, 828, 830, 832, and 834.

System controller 802 is configured to: communicate with memory 804 via communication channel 822; communicate with DAS 810 via communication channel 824; communicate with communication module 812 via communication channel 826; communicate with APS 814 via communication channel 828; communicate with infotainment system 816 via communication channel 830; communicate with sensor system 818 via communication channel 832; and communicate with GPS module 820 via communication channel 834.

GPS module 820 is additionally configured to communicate with a GPS network (not shown) via a wireless communication channel 836.

Communication module 812 is additionally configured to communicate with one or more external communication networks (not shown) via at least one wireless communication channel 838.

In this example, system controller 802, memory 804, DAS 810, communication module 812, APS 814, infotainment system 816, sensor system 818, and GPS module 820 are illustrated as individual elements of vehicle 114. However, in one or more embodiments, at least two of system controller 802, memory 804, DAS 810, communication module 812, APS 814, infotainment system 816, sensor system 818, and GPS module 820 may be combined as a unitary device. Further, in one or more embodiments, at least one of system controller 802, memory 804, DAS 810, communication module 812, APS 814, infotainment system 816, sensor system 818, and GPS module 820 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), random access memory (RAM), dynamic random access memory (DRAM), read-only memory (ROM), electrically erasable programmable read-only memory (EEPROM), compact disk ROM (CD-ROM) or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to vehicle 114 such that the processor may read information from and write information to the tangible computer-readable media. In the alternative, the tangible computer-readable media may be integral to vehicle 114. The tangible computer-readable media may reside in an integrated circuit (IC), an application specific integrated circuit (ASIC), or large-scale integrated circuit (LSI), system LSI, super LSI, or ultra LSI components that perform a part or all of the functions described herein. In the alternative, the tangible computer-readable media may reside as discrete components.

Example tangible computer-readable media may be also coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

System controller 802 may be any device or system that is configured to control the operation of vehicle 114. System controller 802 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of vehicle 114 in accordance with one or more embodiments described in the present disclosure.

Memory 804 may be any device or system capable of storing data, parking program 806, databases 808, and instructions used by system controller 802 and includes, but is not limited to, RAM, DRAM, a hard drive, a solid-state drive, ROM, EPROM, EEPROM, flash memory, embedded memory blocks in an FPGA, or any other various layers of memory hierarchy.

Parking program 806 controls the operations of system controller 802. Parking program 806, having a set (at least one) of program modules, may be stored in memory 804 by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the disclosure as described herein.

As will be described in greater detail below, in one or more embodiments, parking program 806 includes instructions, that when executed by system controller 802, cause system controller to: cause sensor system 818 to measure a magnetic field in an area; cause sensor system 818 to output an area signal based on the magnetic field within the area; and cause APS 814 to output a parking instruction signal (with more precise cm-scale positional precision) based on the area signal. As will be described in greater detail below, in one or more of these embodiments, parking program 806 includes instructions, that when executed by system controller 802, cause system controller to cause a QM magnetometer within sensor system 818 to measure a magnetic field in the area.

As will be described in greater detail below, in one or more embodiments, parking program 806 includes instructions, that when executed by system controller 802, cause system controller to cause APS 814 to analyze a historical and/or seasonal magnetic field map database stored within databases 808, the historical and/or seasonal magnetic field map database including data associated with a previously recorded magnetic field of the area based on a plurality of different time periods.

As will be described in greater detail below, in one or more embodiments, parking program 806 includes instructions, that when executed by system controller 802, cause system controller to cause infotainment system 816 to indicate a location of an available parking space for vehicle 114. As will be described in greater detail below, in one or more of these embodiments, parking program 806 includes instructions, that when executed by system controller 802, cause system controller 802 to cause infotainment system 816 to indicate, via a display, the location of the available parking space for vehicle 114 as a visual indicator including at least one of an icon or an image of the available parking space. As will be described in greater detail below, in one or more of these embodiments, parking program 806 includes instructions, that when executed by system controller 802, cause system controller 802 to cause infotainment system 816 to indicate, via a speaker, the location of the available parking space for vehicle 114 as an audio signal configured to cause the speaker to output a predetermined sound.

As will be described in greater detail below, in one or more embodiments, parking program 806 includes instructions, that when executed by system controller 802, cause system controller to cause DAS 810 to modify a position, a velocity, an acceleration, or combination thereof, of vehicle 114 based on the parking instruction signal.

Infotainment system 816 may be any device or system that is configured to provide audio or video entertainment, non-limiting examples of which include radios, cassette or CD players, automotive navigation systems, video players, universal serial bus (USB) and Bluetooth connectivity, Carputers, in-car internet, and Wi-Fi. Infotainment system 816 may be controlled by simple dashboards knobs and dials, steering wheel audio controls, handsfree voice control, touch-sensitive preset buttons, brain-computer interface, and touch screens.

Sensor system 818 may be any device or system that is configured to detect parameters in an area around vehicle 114.

GPS module 820 may be any device or system that is configured to determine a coarse location of vehicle 114 by receiving and processing GPS satellite signals from a network of GPS satellites orbiting the Earth.

Communication module 812 may be any device or system that is configured to enable vehicle 114 to communicate with an external network using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

APS 814 may be any device or system that is configured to augment position (with greater spatial precision) of vehicle 114, as determined by GPS module 820, via input from sensor system 818.

Each of communication channels 822, 824, 826, 828, 830, 832, and 834 may be any known type of communication channel, including wired and wireless

In operation, GPS module 820 receives GPS signals from at least one GPS satellite orbiting the Earth via wireless communication channel 832. GPS module 820 is configured to analyze the received GPS signals to determine a location of vehicle 114 on the Earth, wherein the location has a resolution on the order of a few meters.

Returning to FIG. 7, after GPS data is obtained (S704), it is determined whether other sensor data is available (S706). For example, returning to FIG. 8, system controller 802 may be configured to execute instructions in parking program 806 to determine whether sensor system 818 has detected any parameters around vehicle 114.

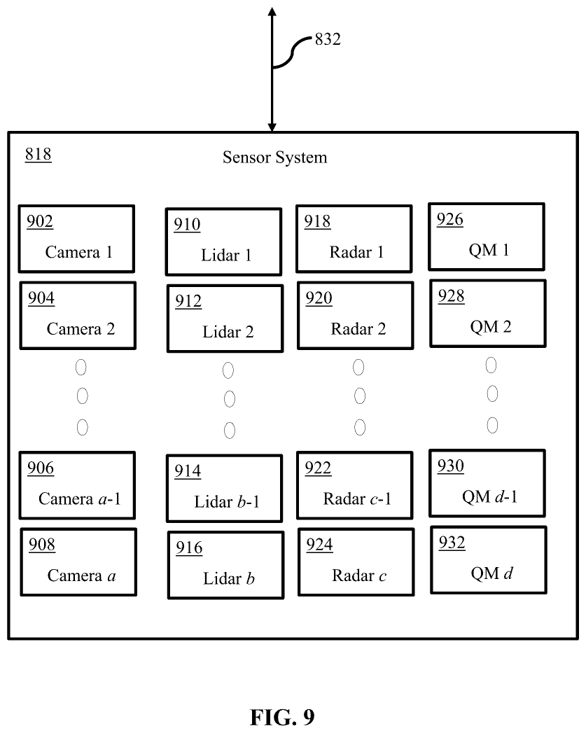

Returning to FIG. 7, if it is determined that other sensor data is available (Y at S706), then other sensor data is obtained (S708). For example, returning to FIG. 8, sensor system 818 may obtain other sensor data. This will be described in greater detail with reference to FIG. 9.

FIG. 9 illustrates a block diagram of sensor system 818.

As shown in the figure, sensor system 818 includes a plurality of sensors, each of which is configured to detect a respective parameter within a respective volume of area around vehicle 114. For purposes of discussion only, the non-limiting examples of the plurality of sensors are indicated as: a number a of cameras including camera 902, camera 904, camera 906, and camera 908, wherein a is a positive integer; a number b of lidars including lidar 910, lidar 912, lidar 914, and lidar 916, wherein b is a positive integer; a number c of radars including radar 918, radar 920, radar 922, and radar 924, wherein c is a positive integer; and a number d of QM magnetometers including QM magnetometer 926, QM magnetometer 928, QM magnetometer 930, and QM magnetometer 932, wherein d is a positive integer.

In this example, the number a of camera, the number b of lidars, the number c of radars, and the number d of QM magnetometers are illustrated as individual elements of sensor system 818. However, in one or more embodiments, at least two of the number a of camera, the number b of lidars, the number c of radars, and the number d of QM magnetometers may be combined as a unitary device.

In one or more embodiments, the number a of cameras corresponds to a number a of cameras at different locations around vehicle 114, wherein each camera has the same imaging capabilities.

In one or more embodiments, the number a of cameras corresponds to a number a of cameras at different locations around vehicle 114, wherein one or more of the cameras has an imaging capability that is different from one or more of the other cameras. For a non-limiting example, one camera may be able to image in the visible spectrum, whereas another camera may be able to image in the infra-red spectrum. For example, one camera may be able to image in the visible spectrum, whereas another camera may be able to image in the infra-red spectrum.

In one or more embodiments, the number b of lidars corresponds to a number b of lidars at different locations around vehicle 114, wherein each lidar has the same detecting capabilities.

In one or more embodiments, the number b of lidars corresponds to a number b of lidars at different locations around vehicle 114, wherein one or more of the lidars has a detecting capability that is different from one or more of the other lidars. For a non-limiting example, one lidar may be able to detect in a 120° field of view at a distance of 30 meters, whereas another lidar may be able to detect in a 30° field of view at a distance of 100 meters.

In one or more embodiments, the number c of radars corresponds to a number c of radars at different locations around vehicle 114, wherein each radar has the same detecting capabilities.

In one or more embodiments, the number c of radars corresponds to a number c of radars at different locations around vehicle 114, wherein one or more of the radars has a detecting capability that is different from one or more of the other radars. For a non-limiting example, one radar may be able to detect in a 180° field of view at a distance of 100 meters, whereas another radar may be able to detect in a 45° field of view at a distance of 300 meters.

In one or more embodiments, the number d of QM magnetometers corresponds to a number d of QM magnetometers at different locations around vehicle 114, wherein each QM magnetometer has the same detecting capabilities.

In one or more embodiments, the number d of QM magnetometers corresponds to a number d of QM magnetometers at different locations around vehicle 114, wherein one or more of the QM magnetometers has a detecting capability that is different from one or more of the other QM magnetometers. For a non-limiting example, one QM magnetometer may be able to detect in a 270° field of view at a distance of 5 meters, whereas another QM magnetometer may be able to detect in a 30° field of view at a distance of 10 meters.

For example, returning to FIG. 6A, a single camera configured to image area 620 may obtain image data of area 620. However, as mentioned above, in some situations, such as low lighting, the image data of image area 620 may be insufficient for vehicle 114 to determine whether parking space 606 is occupied by a vehicle. Therefore, in accordance with aspects of the present disclosure, magnetometer data may be obtained to identify an unoccupied parking space.

Returning to FIG. 7, after other sensor data is obtained (S708) or if it is determined that other sensor data is not available (N at S706), then magnetometer data is obtained (S710). For example, returning to FIG. 8, system controller 802 may execute instructions in parking program 806 to cause sensor system 818 to obtain precise spatial positioning magnetometer data.

For example returning to FIG. 9, at least one of QM magnetometers 926, 928, 930, and 932 may detect magnetic fields in an area around vehicle 114 or larger parking lot 112.

Returning to FIG. 6A, a QM magnetometer detects the magnetic fields within area 622. Similarly, as shown in FIG. 6B, the QM magnetometer detects the magnetic fields within area 626. The QM magnetometer may optionally generate, evaluate, or compare with a magnetic field contour map of a larger parking lot 112.

Returning to FIG. 8, the QM magnetometer(s), of sensor system 818, that detects the magnetic fields within an area, provides the data associated with the detected magnetic field to system controller 802 via communication channel 824.

Returning to FIG. 7, after magnetometer data is obtained (S710), a parking location is identified (S712). For example, returning to FIG. 8, system controller 802 executes instructions in parking program 806 to APS 814 to identify a parking location.

For example, with reference to FIG. 6B, when scanning at time t₁, a camera within sensor system 818 may obtain image data from area 624 and a QM magnetometer may obtain magnetic field data from area 626. For example, as shown in FIG. 9, camera 902 may collect image data of area 624, whereas QM magnetometer 926 may obtain magnetic field data of area 626. System controller 802 may execute instructions in parking program 806 to cause system controller 802 to analyze the obtained magnetic field data from area 626 and the obtained image data from area 624 to identify a parking location within parking space 602.

It should be noted that a system in accordance with aspects of the present disclosure is not limited to identifying a parking space based on magnetic field data obtained from a single QM magnetometer and image data from a single camera. In one or more embodiments, additional sensors within sensor system 818 may obtain respective data of parking space 602, wherein the collected sensor data is used to identify a parking location within parking space 602.

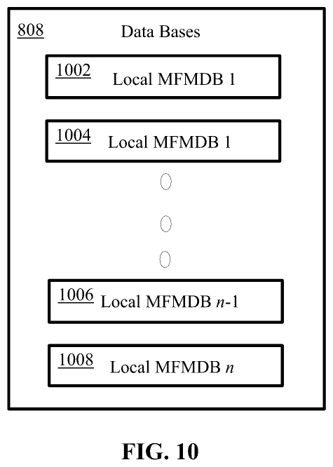

In one or more embodiments, previously recorded magnetic field data of the area or larger parking lot may be analyzed to identify a parking location within parking space 602. This will be described in greater detail with reference to FIG. 10.

FIG. 10 illustrates a block diagram of data bases 808.

As shown in the figure, data bases 808 includes n local magnetic field map data bases,, a sample of which is indicated as local magnetic field map data base (MFMDB) 1002, MFMDB 1004, MFMDB 1006, and MFMDB 1008. Each MFMDB includes data structures having data corresponding to a respective magnetic field map of a respective area.

Historical data is based on information collected from past events, situations, or phenomena that have been previously recorded or recorded over a previous time period. A priori data refers to knowledge or assumptions made based on deductive reasoning or existing information, without relying on empirical evidence or new observations. A priori data is derived from logical reasoning and known facts rather than from experience or experimentation

A historical magnetic field map refers to a map of the magnetic field characteristics of an area that is derived from magnetic field data that was collected from that area at a previous time or over a previous time period. Historical magnetic field map data refers to the data structures of a historical magnetic field map.

An a priori magnetic field map refers to a map of the magnetic field characteristics of an area that is predicted or calculated beforehand, without relying on direct experimental measurements, using theoretical knowledge and assumptions about the system. A priori magnetic field map data refers to the data structures of an a priori magnetic field map.

Magnetic field map data is a more general term that include both historical magnetic field map data and a priori magnetic field map data.

In one or more embodiments, magnetic field map data in each MFMDB includes historical magnetic field map data. In one or more embodiments, magnetic field map data in each MFMDB includes a priori magnetic field map data. In one or more embodiments, magnetic field map data in each MFMDB includes historical magnetic field map data and a priori magnetic field map data.

In one or more embodiments, magnetic field map data in at least one MFMDB includes historical magnetic field map data. In one or more embodiments, magnetic field map data in at least one MFMDB includes a priori magnetic field map data. In one or more embodiments, magnetic field map data in at least one MFMDB includes historical magnetic field map data and a priori magnetic field map data.

In one or more embodiments, magnetic field map data in at least one MFMDB includes historical magnetic field map data, and magnetic field map data in at least one other MFMDB does not include historical magnetic field map data and does include a priori magnetic field map data.

In one or more embodiments, each MFMDB may have magnetic field map data of a magnetic field map of a different respective geographical area. In one or more embodiments, each of these MFMDBs may have been created via data federation from a plurality other vehicles. Data federation is a data integration technique that provides a unified view of data from multiple sources without physically consolidating it. This approach allows organizations to access and manage data from various systems as if it were stored in a single location, while the data remains in its original sources. Further, in one or more of these embodiments, the magnetic field map data may include parking space data that associates distinct parking spaces with the magnetic field map. In this manner, the magnetic fields within a geographical area may be used to distinctly identify parking spaces.

In one or more embodiments, one or more of the MFMDBs may have magnetic field map data of a magnetic field map of the same geographical area, but is based on historical data that is acquired at different time periods. In one or more embodiments, each of these MFMDBs may have been created via data federation from a plurality other vehicles. The different time periods may account for differences in the magnetic field map as a result of changes to the Earth's magnetic field as a function of radiation from the sun. For example, ground-based magnetometers can detect rapid changes in the local magnetic field strength and direction during geomagnetic storms. Further, in one or more of these embodiments, the magnetic field map data may include parking space data that associates distinct parking spaces with the magnetic field map. In this manner, the magnetic fields within the geographical area may be used to distinctly identify parking spaces.

In one or more embodiments, each MFMDB may have magnetic field map data of a magnetic field map of the different geographical areas, wherein the magnetic field map data for each geographical area is periodically updated with data collected from a plurality of other vehicles. Further, in one or more of these embodiments, the magnetic field map data may include parking space data that associates distinct parking spaces with the magnetic field map of each geographical area. In this manner, the magnetic fields within each geographical area may be used to distinctly identify parking spaces.

For example, for purposes of discussion: let magnetic field map data within MFMDB 1002 correspond to the magnetic fields of parking lot 112 when empty; let magnetic field map data within MFMDB 1004 correspond to the magnetic fields of parking lot 112 when full of vehicles as shown inf FIG. 2; let magnetic field map data within MFMDB 1006 correspond to magnetic fields of parking lot 112 as detected by a plurality of different vehicles at different times; and let magnetic field map data within MFMDB 1008 correspond to magnetic fields of parking lot 112 as detected by a single vehicle at a single time.

In one or more embodiments, system controller 802 may execute instructions in parking program 806 to cause APS 814 to compare data received from sensor system 818 with data from databases 808 to identify a parking location.

For example, returning to FIG. 5, the detected magnetic fields 502 and 504 may be compared with magnetic field map data from databases 808, wherein the magnetic field map data corresponds to magnetic field maps that include the area of parking spaces 404 and 402. Further, as mentioned above, in one or more embodiments, such magnetic field map data may include parking space data that associates parking spaces 402 and 404 with the magnetic field map.

Returning to FIG. 8, in one or more embodiments, system controller 802 is configured to executed instructions in parking program 806 to cause APS 814 to generate an area signal based on the magnetic field in a scanned area. For example, with additional reference to FIG. 6B, in one or more embodiments, the generated area signal may correspond to parking space 602, as identified by a camera within sensor system 818 obtaining image data from area 624 and a QM magnetometer obtaining magnetic field data from area 626. In one or more embodiments, the generated area signal may correspond to parking space 602, as identified by a camera within sensor system 818 obtaining image data from area 624 and a QM magnetometer obtaining magnetic field data from area 626, and comparing such data with magnetic field map data from one or more MFMDBs in databases 808.

Returning to FIG. 7, after a parking location is identified (S712), a parking instruction signal is generated (S714). For example, returning to FIG. 8, system controller 802 is configured to execute instructions in parking program 806 to cause APS 814 to generate a parking instruction signal including precise spatial positioning based on the area signal.

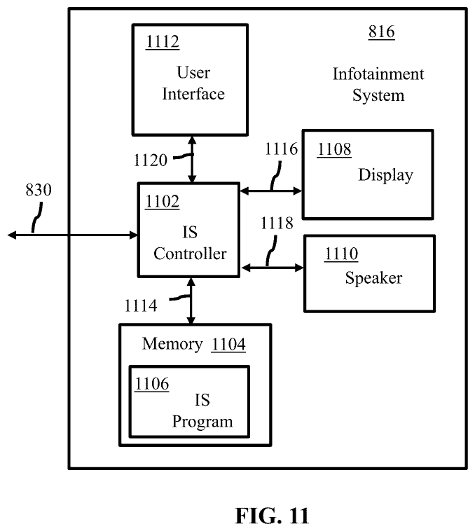

In one or more embodiments, APS 814 may generate a parking instruction signal to cause infotainment system to indicate the available parking space to a driver. This will be described in greater detail with reference to FIG. 11.

FIG. 11 illustrates a block diagram of infotainment system 816.

As shown in the figure, infotainment system 816 includes an infotainment system (IS) controller 1102, a memory 1104 having an IS program 1106 stored therein, a display 1108, a speaker 1110, a user interface (UI) 1112, and communication channels 1114, 1116, 1118, and 1120.

In this example, IS controller 1102, memory 1104, display 1108, speaker 1110, and UI 1112 are illustrated as individual elements of infotainment system 816. However, in one or more embodiments, at least two of IS controller 1102, memory 1104, display 1108, speaker 1110, and UI 1112 may be combined as a unitary device. Further, in one or more embodiments, at least one of IS controller 1102, memory 1104, display 1108, speaker 1110, and UI 1112 may be implemented as a computer having non-transitory computer-readable media for carrying or having computer-executable instructions or data structures stored thereon.

IS controller 1102 may be any device or system that is configured to control the operation of infotainment system 816. IS controller 1102 may be implemented as a hardware processor such as a microprocessor, a multi-core processor, a single core processor, an FPGA, a microcontroller, an ASIC, a DSP, or other similar processing device capable of executing any type of instructions, algorithms, or software for controlling the operation and functions of infotainment system 816 in accordance with one or more embodiments described in the present disclosure.

Memory 1104 may be any device or system capable of storing data, IS program 1106 and instructions used by controlling IS controller 1102 and includes, but is not limited to, RAM, DRAM, a hard drive, a solid-state drive, ROM, EPROM, EEPROM, flash memory, embedded memory blocks in an FPGA, or any other various layers of memory hierarchy.

IS program 1106 controls the operations of IS controller 1102. IS program 1106, having a set (at least one) of program modules, may be stored in memory 1104 by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the disclosure as described herein.

Display 1108 may be any device or system that is configured to display an output of IS controller 1102 for a user.

Speaker 1110 may be any device or system that is configured to output sound.

UI 1112 may be any device or system that is configured to enable a user to access and control IS controller 1102. UI 1112 may include one or more layers including a human-machine interface (HMI) machines with physical input hardware such a keyboards, mice, game pads and output hardware such as computer monitors, speakers, and printers. Additional UI layers in UI 1112 may interact with one or more human senses, including: tactile UI (touch), visual UI (sight), and auditory UI (sound).

Each of communication channels 1114, 1116, 1118, and 1120 may be any known type of communication channel, including wired and wireless.

In operation, upon receiving the parking instruction signal from system controller 802, in one or more embodiments, IS controller may execute instructions in IS program 1106 to cause display 1108 to indicate a location of the available parking space for vehicle 114 as a visual indicator comprising at least one of an icon or an image of the available parking space.

In one or more other embodiments, IS controller may execute instructions in IS program 1106 to cause speaker 1110 to indicate a location of, or driver instructions related to, the available parking space for vehicle 114 as an audio signal configured to cause speaker 1110 to output a predetermined sound.

Returning to FIG. 8, in one or more other embodiments, system controller 802 may execute instructions in parking program 806 to cause DAS 810 to modify a position, a velocity, an acceleration, or combination thereof, of vehicle 114 based on the parking instruction signal. For example, DAS 810 may implement an automated parking maneuver wherein DAS 810 autonomously parks vehicle 114, thereby taking over the steering and velocity of vehicle 114 from the driver, so as to change a position, a velocity, an acceleration, or combination thereof, of vehicle 114 in order to autonomously park vehicle 114.

The Society of Automotive Engineers (SAE) has defined six levels of driving automation, which are widely accepted in the automotive industry. These levels range from 0 to 5, with each level representing increasing autonomy. Level 0 includes no driving automation, wherein the driver is in complete control of all driving tasks, though the vehicle may have some automated warning systems or emergency interventions. Level 1 is drawn to an automated vehicle that includes driver assistance, wherein the vehicle can assist with either steering or acceleration/braking, but not both simultaneously and the driver must remain fully engaged. Level 2 is drawn to an automated vehicle that includes partial driving automation, wherein the vehicle can control both steering and acceleration/braking under specific conditions, but the driver must stay alert and ready to take control. Level 3 is drawn to an automated vehicle that includes conditional driving automation, wherein the vehicle can handle all aspects of driving under certain conditions, but the driver must be ready to take over when requested. Level 4 is drawn to an automated vehicle that includes high driving automation, wherein the vehicle can perform all driving tasks without human intervention under specific conditions or in limited areas. In some cases, human drivers are not needed to operate the vehicle. Level 5 is drawn to an automated vehicle that includes full driving automation, wherein the vehicle is capable of performing all driving tasks under all conditions that a human driver could handle, without any human intervention. These levels provide a framework for understanding the progression of autonomous vehicle technology and help guide regulations and development in the automotive industry.

In the example discussed above, DAS 810 may modify a position, a velocity, an acceleration, or combination thereof, of vehicle 114 based on the parking instruction signal, wherein vehicle 114 is an automated vehicle in accordance with SAE's automation driving levels 2 or 3. In one or more embodiments, DAS 810 may modify a position, a velocity, an acceleration, or combination thereof, of vehicle 114 based on the parking instruction signal, wherein vehicle 114 is an automated vehicle in accordance with SAE's automation driving levels 4 and 5.

Returning to FIG. 7, after a parking instruction signal is generated (S714), method 700 stops (S716).

The foregoing description of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to enable others skilled in the art to best utilize one or more embodiments in the disclosure in various embodiments and with various modifications as are suited to the particular use contemplated. It is intended that the scope of the disclosure be defined by the claims appended hereto.

What is claimed is:

1. A system for use with a vehicle, said system comprising:
a quantum material magnetometer configured to measure a magnetic field in an area and to output an area signal based on the magnetic field in the area; and
an augmented positioning system configured to output a parking instruction signal based on the area signal.

2. The system of claim 1, further comprising a memory having a magnetic field map database stored therein, the magnetic field map database including data associated with a previously recorded magnetic field of the area.

3. The system of claim 2, wherein the magnetic field map database includes local magnetic field databases including data associated with magnetic fields at different areas, wherein the data associated with magnetic fields at each respective area of the different areas is created from an accumulation a plurality of data as output from different quantum material magnetometers, each of which is configured to measure magnetic fields.

4. The system of claim 3, wherein said memory additionally has a seasonal magnetic field map database stored therein, the seasonal magnetic field map database including data associated with a previously recorded magnetic field of the area based on a plurality of different time periods.

5. The system of claim 1, further comprising:
an indicator configured to indicate a location of an available parking space for the vehicle,
wherein said augmented positioning system comprises:
a memory having parking-assist executable instructions stored therein; and
a processor configured to execute the parking-assist executable instructions to cause said system to cause said indicator to indicate the location of the available parking space based on the parking instruction signal.

6. The system of claim 5,
wherein said indicator comprises at least one of a display and a speaker,
wherein when said indicator comprises the display, said indicator is configured to indicate the location of the available parking space for the vehicle as a visual indicator comprising at least one of an icon or an image of the available parking space, and
wherein when said indicator comprises the speaker, said indicator is configured to indicate the location of the available parking space for the vehicle as an audio signal configured to cause said speaker to output a predetermined sound.

7. The system of claim 1, further comprising:
a drive assist system configured to modify a position, a velocity, an acceleration, or combination thereof, of the vehicle based on the parking instruction signal,
wherein the vehicle comprises an automated vehicle.

8. A method comprising:
measuring, via a quantum material magnetometer, a magnetic field in an area;
outputting, via the quantum magnetometer, an area signal based on the magnetic field in the area; and
outputting, via an augmented positioning system, a parking instruction signal based on the area signal.

9. The method of claim 8, wherein said outputting the area signal comprises analyzing, via the augmented positioning system, a magnetic field map database stored within a memory, the magnetic field map database including data associated with a previously recorded magnetic field of the area.

10. The method of claim 9, wherein the magnetic field map database includes local magnetic field databases including data associated with magnetic fields at different areas, wherein the data associated with magnetic fields at each respective area of the different areas is created from an accumulation a plurality of data as output from different quantum material magnetometers, each of which is configured to measure magnetic fields.

11. The method of claim 10, wherein said outputting the area signal further comprises analyzing, via the augmented positioning system, a seasonal magnetic field map database stored within the memory, the seasonal magnetic field map database including data associated with a previously recorded magnetic field of the area based on a plurality of different time periods.

12. The method of claim 8, further comprising:
indicating, via an indicator, a location of an available parking space for a vehicle, wherein said outputting the parking instruction signal comprises executing, via a processor, parking-assist executable instructions stored within a memory to cause the indicator to indicate the location of the available parking space based on the parking instruction signal.

13. The method of claim 12,
wherein said indicating the location comprises indicating via at least one of a display and a speaker,
wherein when said indicating the location comprises indicating via the display, said indicating the location comprises indicating the location of the available parking space for the vehicle as a visual indicator comprising at least one of an icon or an image of the available parking space, and
wherein when said indicating the location comprises indicating via the speaker, said indicating the location comprises indicating the location of the available parking space for the vehicle as an audio signal configured to cause the speaker to output a predetermined sound.

14. The method of claim 8, further comprising:
modifying, via a drive assist system, a position, a velocity, an acceleration, or combination thereof, of the vehicle based on the parking instruction signal,
wherein the vehicle comprises an automated vehicle.

15. A non-transitory, computer-readable media having computer-readable instructions stored thereon, the computer-readable instructions being capable of being read by a system, wherein the computer-readable instructions are capable of instructing the system to perform a method comprising:
measuring, via a quantum material magnetometer, a magnetic field in an area;
outputting, via the quantum material magnetometer, an area signal based on the magnetic field in the area; and
outputting, via an augmented positioning system, a parking instruction signal based on the area signal.

16. The non-transitory, computer-readable media of claim 15, wherein said outputting the area signal comprises analyzing, via the augmented positioning system, a magnetic field map database stored within a memory, the magnetic field map database including data associated with a previously recorded magnetic field of the area.

17. The non-transitory, computer-readable media of claim 16, wherein the magnetic field map database includes local magnetic field databases including data associated with magnetic fields at different areas, wherein the data associated with magnetic fields at each respective area of the different areas is created from an accumulation a plurality of data as output from different quantum material magnetometers, each of which is configured to measure magnetic fields.

18. The non-transitory, computer-readable media of claim 17, wherein said outputting the area signal further comprises analyzing, via the augmented positioning system, a seasonal magnetic field map database stored within the memory, the seasonal magnetic field map database including data associated with a previously recorded magnetic field of the area based on a plurality of different time periods.

19. The non-transitory, computer-readable media of claim 15, the computer-readable instructions being capable of instructing the system to perform the method further comprising:
indicating, via an indicator, a location of an available parking space for a vehicle, wherein said outputting the parking instruction signal comprises executing, via a processor, parking-assist executable instructions stored within a memory to cause the indicator to indicate the location of the available parking space based on the parking instruction signal.

20. The non-transitory, computer-readable media of claim 19,
wherein said indicating the location comprises indicating via at least one of a display and a speaker,
wherein when said indicating the location comprises indicating via the display, said indicating the location comprises indicating the location of the available parking space for the vehicle as a visual indicator comprising at least one of an icon or an image of the available parking space, and
wherein when said indicating the location comprises indicating via the speaker, said indicating the location comprises indicating the location of the available parking space for the vehicle as an audio signal configured to cause the speaker to output a predetermined sound.
